(19) United States
(12) Patent Application Publication
(10) Pub. No.: US 2008/0162971 A1
(43) Pub. Date: Jul. 3, 2008

(54) User Interface for Searches

(75) Inventors: Murali Krishna Punaganti Venkata, Espoo (FI); Chand Malu, Vantaa (FI)

Correspondence Address: PERMAN & GREEN, 425 POST ROAD, FAIRFIELD, CT, 06824, US

(73) Assignee: Nokia Corporation, Espoo (FI)

(21) Appl. No.: 11/618,101

(22) Filed: Dec. 29, 2006

(51) Int. Cl. G06F 1/00

(52) U.S. Cl. 713/324

(57) ABSTRACT

A method including activating a standby mode of a device, where the standby mode includes a search function, inputting a search criteria and searching an application based on the search criteria while in the standby mode.

### BACKGROUND

1. Field

The disclosed embodiments relate to user interfaces, and more particularly, to user interfaces for searching information.

2. Brief Description of Related Developments

The search function of, for example, electronic devices such as computers, personal digital assistants (PDA), mobile phones and the like, is one of the most commonly used functions. These search functions are used to search in browsers, such as for example web browsers, and in the desktop of the electronic device. The search functions may provide a user of the device with quick and easy access to items stored within the device or obtained from an internet or intranet.

In for example, conventional mobile phones, when the device is in a standby or idle state the keypad of the device only accepts numerical input. This numeric input is generally considered as a phone number the user of the device is going to call or store in the device. When the user initiates the call or activates a memory feature of the device the number is either dialed or stored in the device. To access a search mode from a standby state of the device the user navigates through several menu structures of the device to find a search function that allows the user to search for items stored in the device or obtained from an internet or intranet.

It would be advantageous to be able to search for items quickly and easily without navigating through several menu structures to arrive at a search feature of the device.

### SUMMARY

In one exemplary embodiment, an apparatus is provided. The apparatus includes a display and a processor configured to present a search function to a user while the apparatus is in a standby mode.

In one embodiment, a method is provided. The method includes activating a standby mode of a device, where the standby mode includes a search function, inputting a search criteria and searching an application based on the search criteria while in the standby mode.

In one embodiment a computer program product is provided. The computer program product includes a computer useable medium having computer readable code means embodied therein for causing a computer to search an application while in a standby mode. The computer readable code means in the computer program product includes computer readable program code means for causing a computer to activate a standby mode, where the standby mode includes a search function, computer readable program code means for causing a computer to recognize an input a search criteria and computer readable program code means for causing a computer to search an application based on the search criteria while in the standby mode.

### BRIEF DESCRIPTION OF THE DRAWINGS

The foregoing aspects and other features of the disclosed embodiments are explained in the following description, taken in connection with the accompanying drawings, wherein:

FIG. 1 shows a device incorporating features of an embodiment;

FIG. 2 shows another device incorporating features of an embodiment;

FIG. 3 is a block diagram illustrating the general architecture of the exemplary mobile devices of FIGS. 2 and 3;

FIG. 4 is a schematic illustration of a cellular telecommunications system, as an example, of an environment in which a communications device incorporating features of an exemplary embodiment may be applied;

FIG. 5 illustrates a block diagram of one embodiment of a typical apparatus incorporating features that may be used to practice aspects of an embodiment;

FIG. 6 illustrates a user interface of the device in accordance with an embodiment;

FIG. 7 illustrates another user interface of the device in accordance with an embodiment;

FIG. 8 shows a user interface of the device in accordance with an embodiment; and

FIG. 9 illustrates a schematic view of device features in accordance with an embodiment.

FIG. 10 illustrates a block diagram of an example of an apparatus incorporating features that may be used to practice aspects of the disclosed embodiments.

### DETAILED DESCRIPTION OF THE EXEMPLARY EMBODIMENT(S)

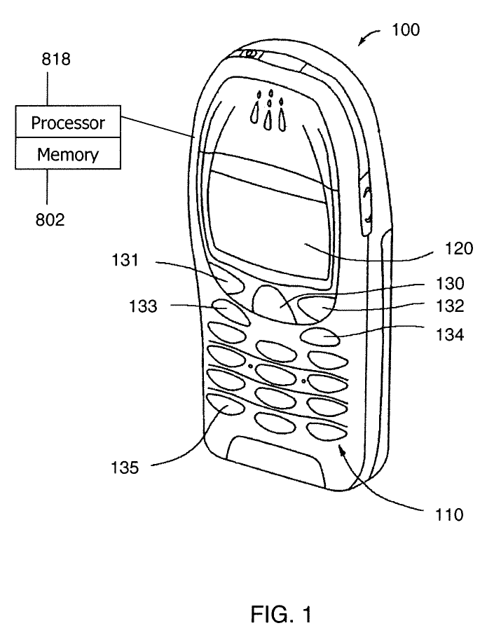

FIG. 1 shows a device 100 incorporating features of an embodiment. Although the embodiments disclosed will be described with reference to the embodiments shown in the drawings, it should be understood that the embodiments disclosed can be embodied in many alternate forms of embodiments. In addition, any suitable size, shape or type of elements or materials could be used.

Although the exemplary embodiments herein will be described with reference to the mobile communications device 100 for exemplary purposes only, it should be understood that the embodiments could be applied equally to any suitable device incorporating, for example, a display, processor, memory and supporting software or hardware for implementing aspects of the disclosed embodiments. The device 100 may have at least one standby or idle mode that is activated when the device is not in use (e.g. when the user is not making a call or otherwise operating the device). For example, the device 100 may have a phone standby mode and a search standby mode. The phone standby mode may operate as a conventional standby mode where the device 100 recognizes keypad input as numerical values which may or may not be associated with a phone number. The search standby mode, which will be described in greater detail below, may allow a user to input alphanumeric entries into the device. In alternate embodiments, the phone standby mode and the search standby mode may be one in the same. The standby mode may be activated automatically after, for example, a predetermined amount of time when the device is not in use. In other embodiments the standby mode may be activated by the user through any suitable setting menu, key on the device, a touch screen input, and the like.

The search function of the device may allow a user to search any suitable medium such as for example, a memory 302 of the device 100 or the internet/world wide web while the device is in the standby mode. A user may employ the search function to search for suitable information stored in the device such as, for example, phone book entries, calendar entries and the like. The search function may also allow the user to search for any suitable information on the internet. There may be a settings menu for the search function that allows the user to select or associate the search function with a particular search engine that may be used for searching within the device and/or outside the device (e.g. the internet/intranet, etc.). In other embodiments, a default search engine may be associated with the search function during manufacture of the device 100 where the default search engine may or may not be changeable by the user. In alternate embodiments, the search function may allow a user to search the contents of other external or peripheral devices such as other computers, mobile phones, PDAs, memory cards and the like. The other devices may be searchable via any suitable wired or wireless communications link such as bluetooth, infrared and the like.

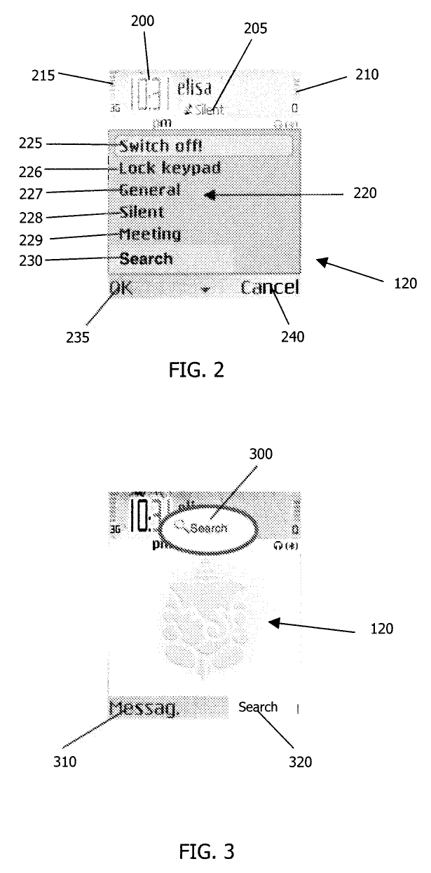

Referring now to FIG. 2, exemplary information that may be displayed on the display 120 of the device 100 is illustrated. The display may include any suitable information such as for example, a service signal strength indicator 215, a battery indicator 210, the active ringing or alert mode for incoming calls and/or messages 205, the time 200 and soft key functions 235, 240. The display may also include any suitable menu such as, for example, a power button menu 220. The power button menu may include any suitable options 225-230 such as, for example, options that may allow a user to turn off 225 the device 100, lock 626 the keypad 110 of the device, set the alert (e.g. ring style) or mode 228, 229, etc. The menu 220 may also include an option 230 for activating a search function of the device. Although, the search option is described as being in the power button menu 220, it is noted that the search function option may be included in any suitable menu of the device. In other embodiments, the search function option may be presented as one of the soft key functions.

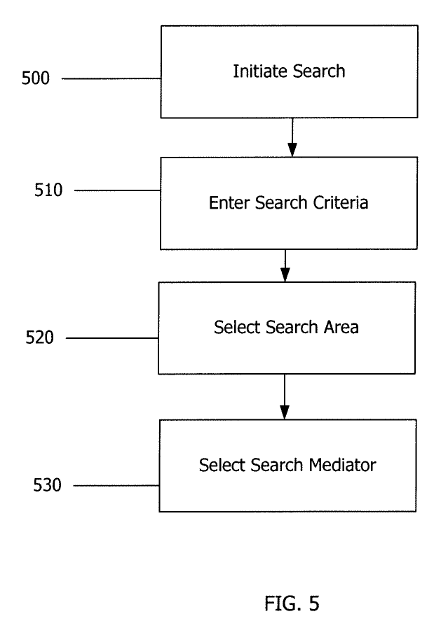

As can be seen in FIG. 3, the search function may be active during a standby mode of the device 100 (i.e. the search standby mode). In the search standby mode the display 120 of the device 100 may indicate that it is in the search standby mode with any suitable indicator such as indicator 300 shown in FIG. 3. The search option may also appear as one of the soft key functions 320 of the search standby mode. In FIG. 3 the search option is shown as being associated with soft key function 320 but in alternate embodiments the search option may be presented as soft key function 310. While in the search standby mode, a user may activate or initiate a search in any suitable manner (FIG. 5, Block 500). For example, the user may employ the soft key function 320 to initiate the search. In other embodiments the user may initiate the search by entering alphanumeric characters through the keypad 110 or a touch screen display of the device.

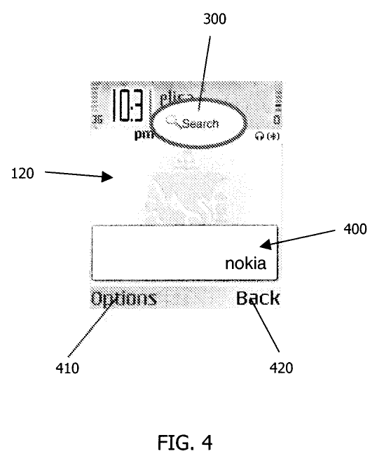

When the search is initiated the display 120 of the device 100 may display alphanumeric characters entered by the user in any suitable area of the display (FIG. 5, Block 510). For example, as can be seen in FIG. 4, a box 400 is displayed for entering the characters. In alternate embodiments, the box 400 may be displayed when the search standby mode is activated. These characters may represent a search criteria or profile for which the user will search. As can be seen in FIG. 4, the soft key functions 410, 420 may change to represent any suitable options associated with the search function of the device 100. For example, in this embodiment, soft key function 410 may present additional search options to the user. These additional search options may include, but are not limited to, whether the user will search all available search areas (internet, within the device, other devices, etc.), a memory of the device, the internet, an intranet, any suitable media, search in the background etc. The user may be able to select a particular area of the device 100 to search (e.g. phone book, calendar, internet, etc.), a particular web site, a peripheral or external device and the like (FIG. 5, Block 520). The additional search option may allow a user to select one or more search mediators to employ during the search such as, for example, internet search engines for searching the web or device search engines for searching within a memory of the device (FIG. 5, Block 500). The user may also be presented, through the options function 410, with the ability to place a call or send a message without exiting the search standby mode. The back option 420 may allow the user to return to a previous state of the device such as the standby mode display shown in FIG. 4. In alternate embodiments, the search options may be accessed through the navigation or scroll key 130 of the device 100. The user may be able to set a default search mode via any suitable settings or options menu. For example, the device 100 may be configured so that when the search is initiated all available search areas are searched for a certain search criteria. This default setting may be changed by the user via the settings or options menu.

In alternate embodiments, the search function described herein may be accessed in any suitable manner when the device is not in a standby mode. For example, the user may activate the search function through any suitable key the keypad 120, a soft key 131, 132 function, a menu option and the like.

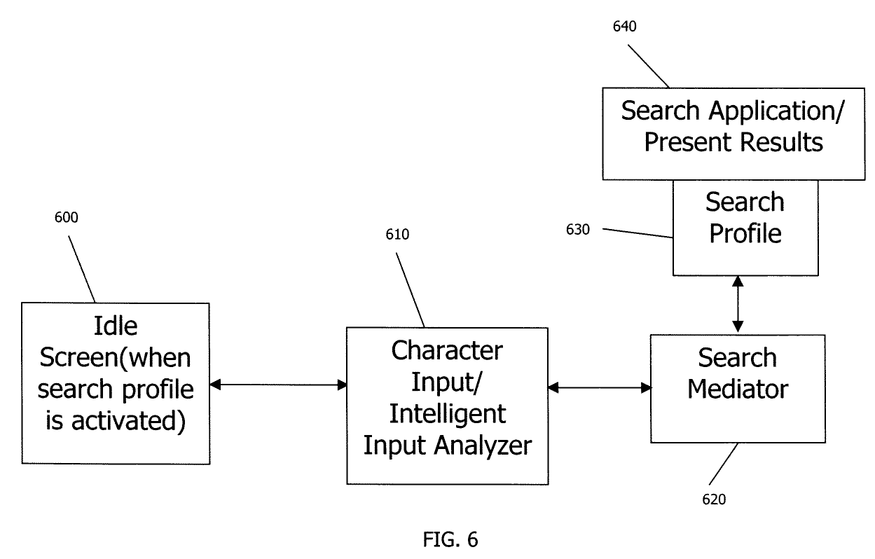

Referring to FIG. 6, the operation of the search function will be described. The user places the device 100 into a search standby mode and the search standby screen is displayed on the device 100 (FIG. 6, Block 600). The user may input characters (i.e. search criteria), which may be analyzed by an intelligent input analyzer (FIG. 6, Block 610). The input analyzer may aid with the inputting of words and phrases by predicting the words and phrases the user is entering. When the desired search criteria are entered by the user, the user may select a search area and/or a search mediator as described above and initiate the search in any suitable manner (FIG. 6, Block 620). For example, the call key 133 may be used to start the search. In other embodiments the scroll key 130 or an options menu may be used to start the search. A search profile is generated based on the search criteria (FIG. 6, Block 630). The application (e.g. calendar, phone book, internet, other device, etc.) is searched and the search results are presented to the user through the display 120 of the device 100 (FIG. 6, Block 640).

Referring again to FIG. 1, the device 100 may be any suitable device such as terminal or mobile communications device 100. The terminal 100 may have a keypad 110 and a display 120. The keypad 110 may include any suitable user input devices such as, for example, a multi-function/scroll key 130, soft keys 131, 132, a call key 133 and end call key 134 and alphanumeric keys 135. The display 120 may be any suitable display, such as for example, a touch screen display or graphical user interface. The display may be integral to the device 100 or the display may be a peripheral display connected to the device 100. A pointing device, such as for example, a stylus, pen or simply the user's finger may be used with the display 120. In alternate embodiments any suitable pointing device may be used. In other alternate embodiments, the display may be a conventional display. The device 100 may also include other suitable features such as, for example, a camera, loud speaker, connectivity port or tactile feedback features. The mobile communications device may have a processor 818 connected to the display for processing user inputs and displaying information on the display 120. A memory 802 may be connected to the processor 818 for storing any suitable information and/or applications associated with the mobile communications device 100 such as phone book entries, calendar entries, web browser, etc.

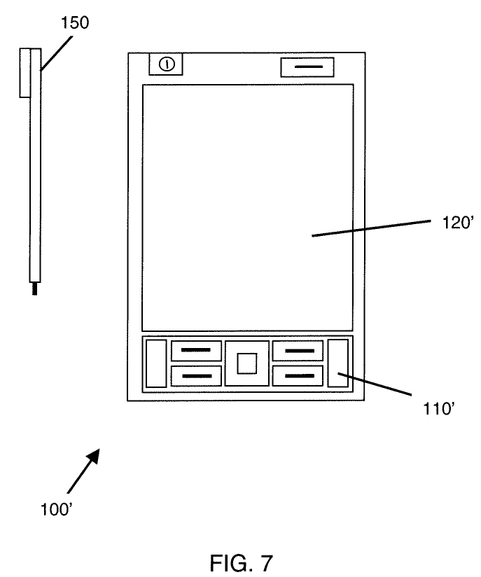

In one embodiment, the device, may be for example, a PDA style device 100′ illustrated in FIG. 7. The PDA 100′ may have a keypad 110′, a touch screen display 120′ and a pointing device 150 for use on the touch screen display 120′. In still other alternate embodiments, the device may be a personal communicator, a tablet computer, a laptop or desktop computer, a television or television set top box or any other suitable device capable of containing the display 120 and supported electronics such as the processor 818 and memory 802.

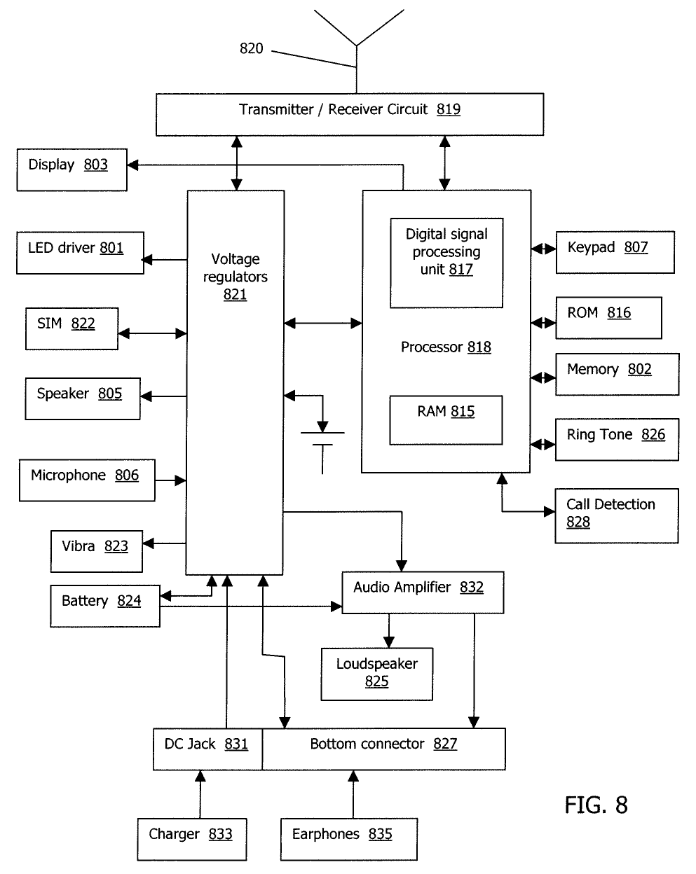

FIG. 8 illustrates in block diagram form one embodiment of a general architecture of the mobile devices 100. The mobile communications device 100 may have a processor 818 connected to the display 803 for processing user inputs and displaying information on the display 803. The processor 818 controls the operation of the device and can have an integrated digital signal processor 817 and an integrated RAM 815. The processor 818 controls the communication with a cellular network via a transmitter/receiver circuit 819 and an antenna 820. A microphone 806 is coupled to the processor 818 via voltage regulators 821 that transform the user's speech into analog signals. The analog signals formed are A/D converted in an A/D converter (not shown) before the speech is encoded in the DSP 817 that is included in the processor 818. The encoded speech signal is transferred to the processor 818, which e.g. supports, for example, the GSM terminal software. The digital signal-processing unit 817 speech-decodes the signal, which is transferred from the processor 818 to the speaker 805 via a D/A converter (not shown).

The voltage regulators 821 form the interface for the speaker 805, the microphone 806, the LED drivers 801 (for the LEDS backlighting the keypad 807 and the display 803), the SIM card 822, battery 824, the bottom connector 827, the DC jack 831 (for connecting to the charger 833) and the audio amplifier 832 that drives the (hands-free) loudspeaker 825.

The processor 818 can also include memory 802 for storing any suitable information and/or applications associated with the mobile communications device 100 such as phone book entries, calendar entries, etc.

The processor 818 also forms the interface for peripheral units of the device, such as for example, a (Flash) ROM memory 816, the graphical display 803, the keypad 807, a ringing tone selection unit 826, and an incoming call detection unit 828. In alternate embodiments, any suitable peripheral units for the device 100 can be included.

The software in the RAM 815 and/or in the flash ROM 816 contains instructions for the processor 818 to perform a plurality of different applications and functions such as, for example, those described herein.

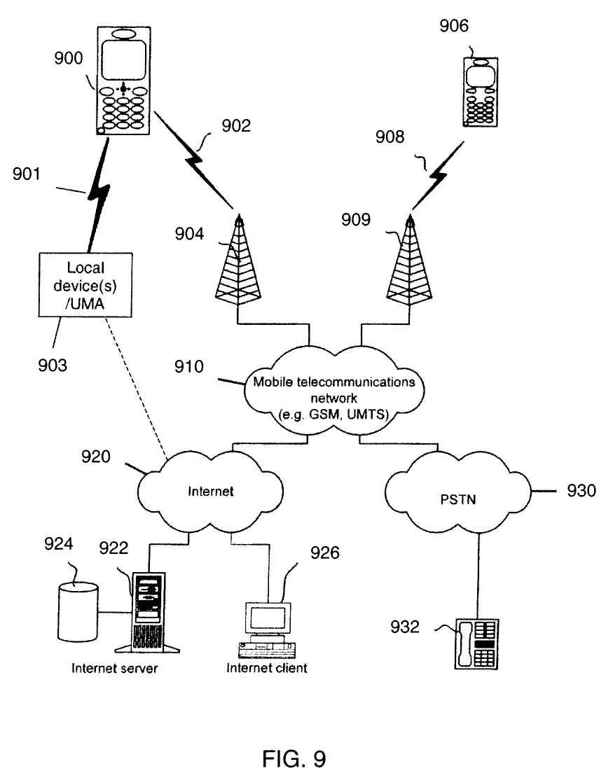

FIG. 9 is a schematic illustration of a cellular telecommunications system, as an example, of an environment in which a communications device 900 incorporating features of an embodiment may be applied. Communication device 900 may be substantially similar to that described above with respect to terminal 100. In the telecommunication system of FIG. 9, various telecommunications services such as cellular voice calls, www/wap browsing, cellular video calls, data calls, facsimile transmissions, music transmissions, still image transmission, video transmissions, electronic message transmissions and electronic commerce may be performed between the mobile terminal 900 and other devices, such as another mobile terminal 906, a stationary telephone 932, or an internet server 922. It is to be noted that for different embodiments of the mobile terminal 900 and in different situations, different ones of the telecommunications services referred to above may or may not be available. The aspects of the invention are not limited to any particular set of services in this respect.

The mobile terminals 900, 906 may be connected to a mobile telecommunications network 910 through radio frequency (RF) links 902, 908 via base stations 904, 909. The mobile telecommunications network 910 may be in compliance with any commercially available mobile telecommunications standard such as GSM, UMTS, D-AMPS, CDMA2000, FOMA and TD-SCDMA.

The mobile telecommunications network 910 may be operatively connected to a wide area network 920, which may be the internet or a part thereof. An internet server 922 has data storage 924 and is connected to the wide area network 920, as is an internet client computer 926. The server 922 may host a www/hap server capable of serving www/hap content to the mobile terminal 900.

For example, a public switched telephone network (PSTN) 930 may be connected to the mobile telecommunications network 910 in a familiar manner. Various telephone terminals, including the stationary telephone 932, may be connected to the PSTN 930.

The mobile terminal 900 is also capable of communicating locally via a local link 901 to one or more local devices 903. The local link 901 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 903 can, for example, be various sensors that can communicate measurement values to the mobile terminal 900 over the local link 901. The above examples are not intended to be limiting, and any suitable type of link may be utilized. The local devices 903 may be antennas and supporting equipment forming a WLAN implementing Worldwide Interoperability for Microwave Access (WiMAX, IEEE 802.16), WiFi (IEEE 802.11x) or other communication protocols. The WLAN may be connected to the internet. The mobile terminal 900 may thus have multi-radio capability for connecting wirelessly using mobile communications network 910, WLAN or both. Communication with the mobile telecommunications network 910 may also be implemented using WiFi, WiMax, or any other suitable protocols, and such communication may utilize unlicensed portions of the radio spectrum (e.g. unlicensed mobile access (UMA)).

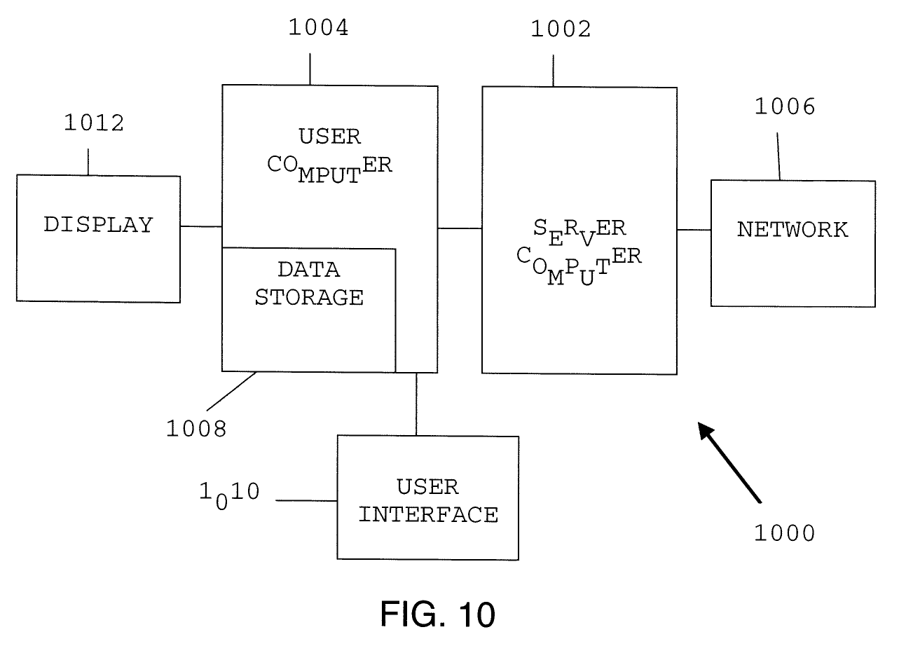

The disclosed embodiments may also include software and computer programs incorporating the process steps and instructions described herein that are executed in different computers. FIG. 10 is a block diagram of one embodiment of a typical apparatus 1000 incorporating features that may be used to practice aspects of the embodiments. As shown, a computer system 1002 may be linked to another computer system 1004, such that the computers 1002 and 1004 are capable of sending information to each other and receiving information from each other. In one embodiment, computer system 1002 could include a server computer adapted to communicate with a network 1006. Computer systems 1002 and 1004 can be linked together in any conventional manner including, for example, a modem, hard wire connection, or fiber optic link. Generally, information can be made available to both computer systems 1002 and 1004 using a communication protocol typically sent over a communication channel or through a dial-up connection on ISDN line. Computers 1002 and 1004 are generally adapted to utilize program storage devices embodying machine readable program source code which is adapted to cause the computers 1002 and 1004 to perform the method steps disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 1002 and 1004 may also include a microprocessor for executing stored programs. Computer 1002 may include a data storage device 1008 on its program storage device for the storage of information and data. The computer program or software incorporating the processes and method steps incorporating aspects of the invention may be stored in one or more computers 1002 and 1004 on an otherwise conventional program storage device. In one embodiment, computers 1002 and 1004 may include a user interface 1010, and a display interface 1012 from which aspects of the invention can be accessed. The user interface 1010 and the display interface 1012 can be adapted to allow the input of queries and commands to the system, as well as present the results of the commands and queries.

The embodiments described herein provide a user with an easy and fast way to initiate a search using, for example, a mobile device while providing a single user interface for searching any available media (e.g. external devices, device applications, internet, etc.) while minimizing the number of steps taken to perform the search.

It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. An apparatus comprising:
a display; and
a processor configured to present a search function to a user while the apparatus is in a standby mode.

2. The apparatus of claim 1, wherein the processor is further configured to recognize alphanumeric input while in the standby mode.

3. The apparatus of claim 1, wherein the processor is configured to cause a search of a memory connected to the processor in response to a search criteria entered into the apparatus while in the standby mode.

4. The apparatus of claim 1, wherein the processor is configured to cause a search of at least one of an internet, intranet, world wide web or external device in response to a search criteria entered into the apparatus while in the standby mode.

5. The apparatus of claim 1, wherein the processor is configured to cause an indication to be shown on the display that a search function is active.

6. The apparatus of claim 1, further comprising an input analyzer connected to the processor for predicting user input.

7. A method comprising:
activating a standby mode of a device, where the standby mode includes a search function;
inputting a search criteria; and
searching an application based on the search criteria while in the standby mode.

8. The method of claim 7, wherein the search criteria is input as alphanumeric characters.

9. The method of claim 8, further comprising predicting words and phrases formed by the alphanumeric characters using an input analyzer.

10. The method of claim 7, wherein the application is an application stored in the memory of the device.

11. The method of claim 7, wherein the application is at least one of an external device, internet, intranet or world wide web.

12. The method of claim 7, wherein the search is performed through an internet or world wide web search engine.

13. The method of claim 7, further comprising indicating that the search function is active when the standby mode is activated.

14. The method of claim 7, wherein the standby mode is activated through a menu of the device.

15. The method of claim 7, wherein the user is presented with options for selecting at least one application to be searched.

16. The method of claim 7, wherein the search is initiated by activating a key of the device or selecting a menu item of the device.

17. A computer program product comprising:
a computer useable medium having computer readable code means embodied therein for causing a computer to search an application while in a standby mode, the computer readable code means in the computer program product comprising:
computer readable program code means for causing a computer to activate a standby mode, where the standby mode includes a search function;
computer readable program code means for causing a computer to recognize an input a search criteria; and
computer readable program code means for causing a computer to search an application based on the search criteria while in the standby mode.

18. The computer program product of claim 17, wherein the search criteria is input as alphanumeric characters.

19. The computer program product of claim 17, wherein the application is at least one of an application stored in the memory of the device an external device, internet, intranet or world wide web.

20. The computer program product of claim 17, further comprising computer readable program code means for causing a computer to indicate that the search function is active when the standby mode is activated.
